(19) United States
(12) Patent Application Publication
(10) Pub. No.: US 2001/0056340 A1
(43) Pub. Date: Dec. 27, 2001

(54) CDM simulator for testing electrical devices

(76) Inventors: Igor Anatoly Gorin, San Jose, CA (US); Christopher Thomas Moore, Saratoga, CA (US)

Correspondence Address: Charles H. Jew, BURNS, DOANE, SWECKER & MATHIS, L.L.P., P.O. Box 1404, Alexandria, VA, 22313-1404, US

(21) Appl. No.: 09/886,081

(22) Filed: Jun. 18, 2001

Related U.S. Application Data
(60) Provisional application No. 60/213,997, filed on Jun. 26, 2000.

(51) Int. Cl. G06F 17/50

(52) U.S. Cl. 703/14

(57) ABSTRACT

A CDM simulator for a magnetic recording head can be used for the in situ testing of such heads and also for electrical and/or magnetic characterization. The recording head is disposed in the simulator adjacent a discharge plate of an electrically conductive material with a dielectric layer disposed therebetween. The recording head is resistively coupled to a ground potential. A stored charge is injected into the discharge plate. When the charge is injected, a current transient similar to electrostatic discharge, is developed through the magnetic recording head.

### REFERENCE TO RELATED APPLICATION

This application claims priority to U.S. Provisional Application 60/213,997 filed on Jun. 26, 2000, which is incorporated herein by reference.

### BACKGROUND OF THE INVENTION

1. Field of the Invention

The present invention relates generally to a charged device model (CDM) simulator and, more particularly, to a CDM apparatus and method which allows for the device under test to remain in situ for CDM waveform injection and other electrical or magnetic characterization.

2. Brief Description of the Related Art

CDM testing has typically been performed on integrated circuits (IC) to determine the susceptibility of the design of such circuits to electrostatic discharge damage. Specifically, CDM simulators perform such testing by emulating the extremely fast rise time and high amplitude current event, or current pulse, of an electrostatic discharge that occurs when a statically charged device makes contact with another statically charged object at a substantially different electric potential. For example, a device may acquire charge through a tribo-electric or frictional process and then abruptly touch a grounded surface.

CDM simulators have been specifically designed to inject the necessary test waveforms to IC's and other electrical devices under test, such as magnetic recording heads. The CDM waveform represents a very quick injection of a high amplitude current pulse into the device under test. As part of the CDM testing, electrical and/or magnetic characterization is performed on the IC before and after injecting the CDM waveform to determine the effect of such fast rise time and high amplitude current events.

As in any testing procedure, it is highly desirable that such waveforms be repeatable, as well as consistent in amplitude and form. Moreover, to minimize excessive handling and movement of the device under test, it is also highly desirable that the same test apparatus or system injects the CDM waveform and also performs the electrical and/or magnetic characterization procedures. Having the same apparatus perform all such tests and procedures eliminates the excessive handling and movement that may introduce uncontrolled current transients that can harm sensitive devices under test, such as magnetic recording heads.

Prior art FIG. 1 illustrates one configuration of a CDM simulator 10 useful for the testing of IC's. The prior art simulator 10 includes a field charging electrode 12 embedded in a surface 14 of an insulating fixture 16, a sheet 18 of dielectric material coextensive on the surface 14, and a top ground plane 20. The top ground plane 20 is mounted to a movable support arm 22, which also supports a resistive current probe 24, consisting of a radial resistor 26 and a pogo probe 28, and coaxial cable 30, all of which define the structure of a discharge head 32. To raise the potential of the field charging electrode 12, a switch 34 couples a high voltage power supply 36 to the field charging electrode 12 through a charging resistor 38.

A device under test, such as integrated circuit 40, is placed on the dielectric material 18 within the area bounded by the field charging electrode 12. The electrical potential of the integrated circuit 40 is raised by the field induced charging, or electrostatic induction. More specifically, the switch 34 is closed, thereby raising the potential of the field charging electrode 12 to the voltage of the power supply 36. The test is performed by lowering the discharge head 32 such that the pogo probe 28 comes into contact with one of the pins 42 on the integrated circuit 40. This charge/discharge test can be repeated at the same pin 42 with different voltage levels, and then the same test sequence can be performed at another pin 42, until all such pins have been tested. For each test, the discharge current waveform produced through the pogo probe 28 and the radial resistor 26 can be transmitted through the coaxial cable 30 to an oscilloscope (not shown) for recording, as described in Electronic Industries Association Jedec Standard JESD22-C101, May 1995.

While the prior art CDM simulator 10, described hereinabove with reference to prior art FIG. 1, is particularly useful for the CDM testing of discrete IC's, a disadvantage and limitation of the prior art CDM simulator 10 is that CDM simulator 10 does not allow a CDM waveform to be easily injected into a device under test while such device is mounted within a system that also performs electrical and/or magnetic characterization. For example, the device under test may be a magnetic recording head. In order to perform an electrical and/or magnetic characterization of the magnetic recording head after injecting a CDM waveform, the magnetic recording head must either be moved to a separate testing system, or connection to both sides of the recording head must be made. A further disadvantage and limitation of the prior art CDM simulator 10 is that to properly cause a CDM event to occur, the head must be unconnected while a charging plate, such as the field charging electrode 12, is initially charged. The resultant handling for connection and disconnection of the sensitive magnetic recording head may then further harm the magnetic recording head, as discussed above.

Another known CDM simulator 50 is shown in prior art FIG. 2. The CDM simulator 50 includes a ground plate 52, a grounding conductor 54, a resistor 56 and a normally open mercury lead switch 58. One terminal of the mercury lead switch 58 is connected to the grounding conductor 54 through the resistor 56 and the other terminal of the mercury lead switch 58 is connected to a lead pin 60 of a device under test, such as IC 62. To raise the potential of the IC 62, a switch 64 couples a high voltage power supply 66 to the lead pin 60 of the IC 62. To perform the test, the switch 64 is opened after the IC 62 has been charged, and the mercury lead switch 58 is then closed, thereby discharging the charge on the IC 62 through the mercury lead switch 58 and the resistor 56 to the grounding conductor 54.

A disadvantage and limitation of the CDM simulator 50 of prior art FIG. 2 is that the floating inductance in the lead wires connecting the mercury lead switch 58 to the grounding conductor 54 (through the resistor 56) and the pin 60 of the IC 62 prevents a rapid discharge of current. Accordingly, the waveform developed from the CDM testing may not conform to the standards set forth for CDM simulation.

In addition, as described hereinabove with reference to the CDM simulator 10 of prior art FIG. 1, the CDM simulator 50 of prior art FIG. 2 also does not easily allow testing of magnetic recording heads. For example, connecting the magnetic recording head to test the apparatus through the mercury lead switch results in further disadvantages and limitations of the CDM simulator 50 in that the capacitive coupling between a magnetic recording head under test and the ground plate 52 will be significantly smaller than the parasitic capacitance of the switch 64 used to disconnect the recording head 14 during the attempted injection of CDM waveform. Thus, a capacitive voltage division between the switch 64, the magnetic recording head under test, and the ground plate 52 results in an unacceptable reduction in the voltage of capacitor created by the recording head and the electrically conductive material.

Accordingly, it would be desirable to provide an improved CDM simulator that would provide repeatable and consistent test waveforms and can be used with a same system for performing electrical and/or magnetic characterization of a magnetic recording head or other electrical device.

### SUMMARY OF THE INVENTION

According to the present invention, a CDM simulator for providing a rapid discharge of an electrical current transient to a device under test includes an electrically conductive material having a dielectric layer coextensively disposed thereon wherein the layer is adapted to receive the device under test, a charge capacitor, a normally open discharge switch electrically coupled in series between the electrically conductive material and the charge capacitor defining a first node between the charge capacitor and the discharge switch, a power source connected through a decoupling resistor to the first node to store a charge on the charge capacitor, and a resistor adapted to be electrically connected in series between the charge capacitor and the device under test defining a second node between the resistor and the charge capacitor. The second node is normally grounded. Closing of the discharge switch subsequent to the charge being stored on the charge capacitor causes the current transient to be discharged through the device under test.

A feature of the present invention is that the test circuit, defined by the resistor, the charge capacitor, the discharge switch, the electrically conductive material with the dielectric layer may have its inductance determined to ensure that the current transient is within standards for CDM testing. In one embodiment of the present invention, this inductance may be determined by placing a length of a connection wire, having a predetermined inductance per unit length, in series between the resistor and the device under test.

Another feature of the present invention is that when the device under test is placed on the dielectric layer and connected within the test circuit, a small and determinable capacitor is formed in the test circuit by the device and the electrically conductive material. This capacitor advantageously overcomes the limitations and disadvantages of the parasitic capacitances of the prior art devices.

In another embodiment of the present invention, a method for providing the rapid discharge of an electrical current transient to test an electrical device includes spacing proximally the device from an electrical conductive material, connecting resistively the device to a ground potential, and injecting an electrical charge into the electrically conductive material. Accordingly, an electrical current pulse, simulating electrostatic discharge, will be induced in the device under test.

A feature of the present invention is that a small and controllable capacitance is formed by the device under test and the electrically conductive material. This capacitance may be further controlled, in one embodiment, by the placing of a dielectric material between the device and the electrically conductive material which also determines the spacing. This feature of the present invention advantageously eliminates the parasitic capacitances of the prior art.

Another feature of the present invention is that the inductance of the discharge path of the current transient may readily be varied. In one embodiment of the present invention, the variable inductance is achieved by placing variable lengths of a connection wire having a predetermined inductance per unit length electrically connected in series in the discharge path.

These and other objects, advantages and features of the present invention will become readily apparent to those skilled to the art from a study of the following Description of the Exemplary Preferred Embodiments when read in conjunction with the attached Drawing and appended Claims.

### BRIEF DESCRIPTION OF THE DRAWINGS

FIG. 1 (prior art) is a perspective, partial cross-sectional view of a conventional CDM simulator;

FIG. 2 (prior art) is a schematic circuit diagram of another conventional CDM simulator;

FIG. 3 is a schematic circuit diagram of a CDM simulator constructed according to the principles of the present invention; and

FIG. 4 is an exemplary CDM waveform produced by the CDM simulator of the present invention.

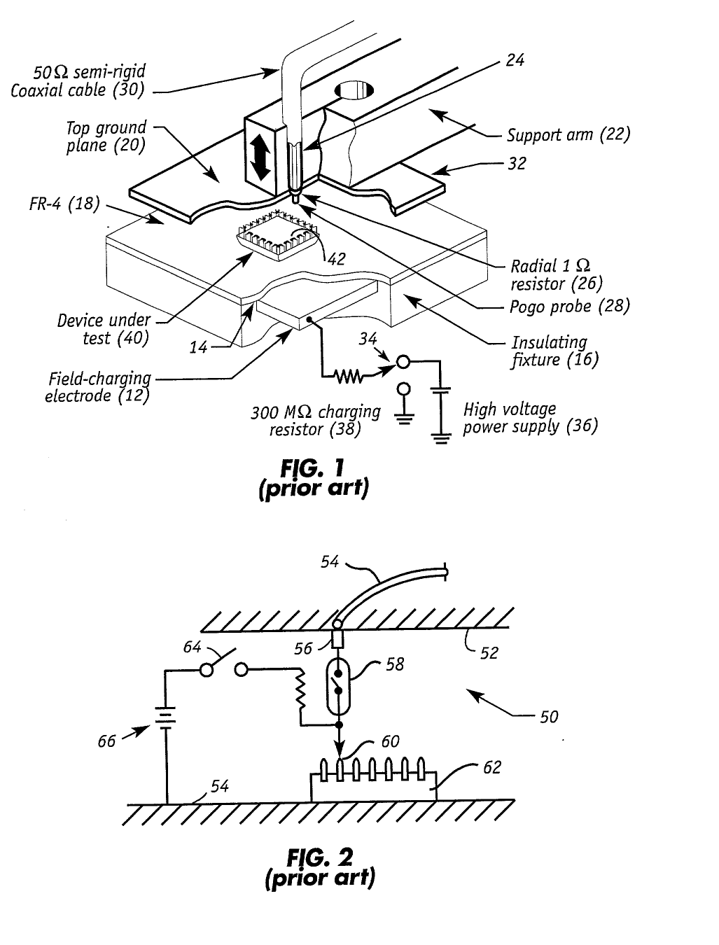

### DESCRIPTION OF THE EXEMPLARY PREFERRED EMBODIMENTS

Referring to FIG. 3, there is shown a CDM simulator 70 constructed according to the principles of the present invention. The CDM simulator 70 includes a test circuit 72 to provide a CDM test waveform to an electrical device under test, for example, a magnetic recording head 74. The test circuit 72 includes a dielectric material 76, a charge plate 78 of electrically conductive material, a relay or discharge switch 80, a charge capacitor 82, a resistor 84, and connection wire 86. The CDM simulator may further include a power source 88.

The dielectric material 76 is disposed coextensively on a first surface 90 of the charge plate 78. The charge plate 78, the switch 80, the charge capacitor 82, the resistor 84 and the connection wire 86 are connected in series as best seen in FIG. 3. The power source 88, when connected to the test circuit 72 is resistively connected to a node 92 between the switch 80 and the charge capacitor 82. For example, resistor 102 between output power source 88 and node 92 provides high frequency decoupling. A node 94 between the charge capacitor 82 and the resistor 84 is coupled to a reference potential, such as ground.

The dielectric material 76 is selected to have predictable and consistent electrical properties, and may be any of, but not limited to, polystyrene, polyester, or polymer materials, or TEFLON or KAPTON materials (available from E. I. du Pont de Nemours and Company). The dielectric material 76 may have a typical thickness between 0.039-0.394 inches (1-10 millimeters). In one preferred embodiment, the thickness of the dielectric material 76 may be 0.078 inches (2 millimeters).

The discharge switch 80 is selected to make a “clean” connection when moved in a direction of arrow A from an open position, as best seen in FIG. 3, to its closed position. Preferably, the discharge switch 80 is a wet relay or a mercury switch, such that after the discharge switch 80 moves to its closed position, the surface tension of the mercury closes the circuit and provides an electrical connection.

The length of the connection wire 86 is predetermined, as described in greater detail hereinbelow. In one preferred embodiment of the present invention, the length of the connection wire 86 may be 1 inch (25.4 millimeter). The overall length of the test circuit 72 may preferably be 2.5 inches (63.5 millimeters).

To set up the CDM simulator 70 to inject a CDM waveform into the magnetic recording head 74, the magnetic recording head 74 is placed on the dielectric material 76, as best seen in FIG. 3, such that the dielectric material 76 separates the magnetic recording head 74 from the charge plate 78. The separation of the magnetic recording head 74 from the charge plate 78 effectively creates a capacitance between the magnetic recording head 74 and the charge plate 78. The spacing between the magnetic recording head 74 and the charge plate 78 is selected such that a small and controlled capacitance may be determined as appropriate for the device under test. The above described thickness of the dielectric material 76 is optimized for the CDM testing of the magnetic recording head 74.

The connection wire 86 electrically connects the magnetic recording head 74 when mounted in the CDM simulator 70. The length of the connection wire 86 is selected as appropriate for the device under test. The above described preferred lengths of the connection wire 86 are optimized for the CDM testing of the magnetic recording head 74.

The length of the connection wire 86 may also be selected to determine the overall inductance in the test circuit 72 when the device under test is placed in the CDM simulator 70. In an alternative embodiment of the present invention, the overall inductance of the test circuit 72 can be adjusted by adjusting the length of the connection wire 86 to achieve the desired CDM waveform or electrical properties.

To complete the set up of the CDM simulator 70, the power source 88 is electrically connected to the node 92 of the test circuit 72 (with the switch 80 in its open position) to induce a charge on the charge capacitor 82. The charge capacitor 82 may then store a predetermined amount of electrical charge, as described in greater detail below. The resistor 84 is selected to provide the proper dampening of the CDM waveform produced when the discharge switch 80 is moved to its closed position.

Once the charge capacitor 82 is fully charged, the discharge switch 80 can move to its closed position, thereby closing the test circuit 72. The charge capacitor 84 quickly discharges the stored electrical charge to the charge plate 78 and thus to the magnetic recording head 24 through the small capacitor formed by the charge plate 78, the dielectric material 76 and the magnetic recording head 74, resulting in an alternating current loop in the test circuit 72. Accordingly, the charge plate 78 acts as part of current transient path in the test circuit 72 rather than just a charge source, as in the hereinabove described prior art CDM simulators.

An electrical and/or magnetic characterization can be performed on the magnetic recording head 74 while still mounted to in the CDM simulator 70 to determine the effect of the quick and high current amplitude event. Furthermore, the magnetic recording head 74 can repeatedly be tested with the high current amplitude event without having to move or remove the magnetic recording head 74 from the CDM simulator 70. In this regard, the discharge switch 80 may again be moved to its open position and the charge capacitor 82 may then be recharged by the power source 88. After fully charging the charge capacitor 82, the discharge switch 80 may then again be moved to its closed position, thereby having the charge capacitor 82 quickly discharging its stored electrical charge to the charge plate 78 and hence to the magnetic recording head 74. Each subsequent test may be performed at the same or different levels of charge, as determined by the output voltage of the power source 88, in accordance with established CDM testing standards.

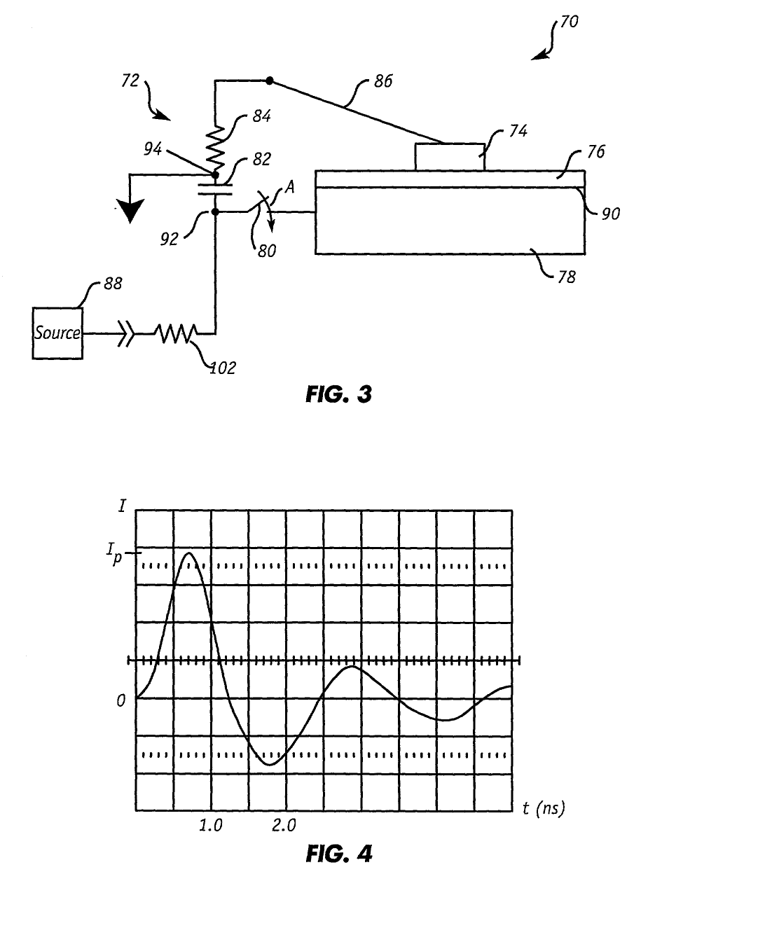

The gating of the charge capacitor 82 through the discharge switch 80 to the charge plate 78 produces a high frequency current transient in the shape of the CDM waveform, as best seen in FIG. 4, that is injected to the magnetic recording head 74. The hereinabove described properties of the components of the test circuit 72, for example, the charge capacitor 82, the resistor 84, and the length of the connection wire 86 are further selected to consistently and repeatedly produce the desired CDM waveform of FIG. 4.

FIG. 4 is a representative CDM waveform. The peak amplitude (Iₚ) is a function of the charging voltage and can be determined knowing the capacitance formed by the device under test and the charging plate 78. The rise time of the waveform is preferably 400 picoseconds, that is the waveform reaches Iₚ within in approximately 400 picoseconds of the moving the discharge switch 80 to its closed position. Furthermore, the width of the first wave in the waveform is preferably between 0.5 and 1.5 nanoseconds. The amplitude of the first ring is preferably less than 50% of lₚ, and the amplitude of the second ring is preferably less than 25% of Iₚ These waveform characteristics are desired for emulating the fast and high current amplitude event that occurs when a statically charged device, for example, the magnetic recording head 24 makes contact with another body at a different electrical potential.

There have been described hereinabove exemplary preferred embodiments of a CDM simulator 70 constructed according to the principles of the present invention. While the preferred construction and operation of the CDM simulator 70 is described above as being optimized for the CDM testing of the magnetic recording head 74, it is to be understood by one skilled in the art that the CDM simulator 70 described herein may also be used to provide a CDM test waveform for other types of electrical devices under test including, but not limited to, IC's, wherein such CDM test may be performed with the device under test in situ. Accordingly, those skilled in the art may now make numerous uses of, and departures from, the above-described preferred embodiments without departing from the principles of the present invention which are defined solely by the scope of the appended claims.

What is claimed is:

1. In a CDM simulator for providing a rapid discharge of an electrical current transient to test an electrical device under test, a test circuit comprising:
an electrically conductive material having a dielectric layer coextensively disposed thereon, said layer being adapted to receive said device when said device is under test;
a charge capacitor;
a normally open discharge switch electrically coupled in series between said electrically conductive material and said charge capacitor defining a first node between said charge capacitor and said discharge switch, said first node being adapted to have a power source resistively connected thereto to store a charge on said charge capacitor; and
a resistor adapted to be electrically connected in series between said charge capacitor and said device when said device is under test defining a second node between said resistor and said charge capacitor, said second node being normally grounded, whereby closing of said discharge switch subsequent to said charge being stored on said charge capacitor causes said current transient to be discharged through said device under test.

2. A test circuit as set forth in claim 1 wherein said discharge switch is a wet relay switch.

3. A test circuit as set forth in claim 1 wherein said discharge switch is a mercury switch.

4. A test circuit as set forth in claim 1 further comprising a connection wire to be coupled electrically intermediate said resistor and said device under test.

5. A test circuit as set forth in claim 4 wherein said connection wire has a predetermined inductance per unit length.

6. A test circuit as set forth in claim 1 wherein said electrically conductive material is a charge plate having a first surface, said dielectric material being disposed on said first surface.

7. A test circuit as set forth in claim 1 further comprising a decoupling resistor electrically connected to said first node, said power source being adapted to connect to said resistor.

8. A CDM simulator for providing a rapid discharge of an electrical current transient to a device under test comprising:
an electrically conductive material having a dielectric layer coextensively disposed thereon, said layer being adapted to receive said device when said device is under test;
a charge capacitor;
a normally open discharge switch electrically coupled in series between said electrically conductive material and said charge capacitor defining a first node between said charge capacitor and said discharge switch;
a power source resistively connected to said first node to store a charge on said charge capacitor; and
a resistor adapted to be electrically connected in series between said charge capacitor and said device when said device is under test defining a second node between said resistor and said charge capacitor, said second node being normally grounded, whereby closing of said discharge switch subsequent to said charge being stored on said charge capacitor causes said current transient to be discharged through said device under test.

9. A CDM simulator as set forth in claim 8 wherein said discharge switch is a wet relay switch.

10. A CDM simulator as set forth in claim 8 wherein said discharge switch is a mercury switch.

11. A CDM simulator as set forth in claim 8 further comprising a connection wire to be coupled electrically intermediate said resistor and said device under test.

12. A CDM simulator as set forth in claim 11 wherein said connection wire has a predetermined inductance per unit length.

13. A CDM simulator as set forth in claim 8 wherein said electrically conductive material is a charge plate having a first surface, said dielectric material being disposed on said first surface.

14. A CDM simulator as set forth in claim 8 further comprising a decoupling resistor electrically connected between said power source and said first node.

15. A method for providing a rapid discharge of an electrical current transient to test in situ an electrical device comprising:
spacing proximally said device from an electrically conductive material; connecting resistively said device to ground potential; and
injecting an electrical charge into said electrically conductive material whereby said current transient is discharged through said device.

16. A method as set forth in claim 15 wherein said spacing includes placing a dielectric material intermediate said electrically conductive material and said device.

17. A method as set forth in claim 15 wherein said injecting includes:
charging a charge capacitor to store said charge thereon;
switching said charge to electrically conductive material.

18. A method as set forth in claim 15 further comprising varying the inductance of a discharge path of said current transient.

19. A method as set forth in claim 18 wherein said varying includes electrically connecting variable lengths of a connection wire having a predetermined inductance per unit length in series between said device and ground potential.

20. A method for providing a rapid discharge of an electrical current transient to test in situ an electrical device comprising:
placing a layer of a dielectric material on a first surface of a discharge plate of an electrically conductive material, said device being placed on said layer;
connecting a resistor in series between said device and ground potential;
connecting a normally open discharge switch and a charge capacitor in series between said resistor and said discharge plate wherein a first node is defined between said discharge switch and said discharge capacitor and a second node is defined between said resistor and discharge capacitor, said second node being coupled to ground potential; and
storing a charge on said charge capacitor, whereby closing of said discharge switch injects said charge into said electrically conductive material whereby said current transient is discharged through said device.

21. A method as set forth in claim 20 wherein said storing includes connecting a power source through a decoupling resistor to said first node when said discharge switch is open.

22. A method as set forth in claim 20 further comprising varying the inductance of a discharge path of said current transient.

23. A method as set forth in claim 22 wherein said varying includes electrically connecting variable lengths of a connection wire having a predetermined inductance per unit length in series between said device and said resistor.
